(19) United States
(12) Patent Application Publication
(10) Pub. No.: US 2005/0044833 A1
(43) Pub. Date: Mar. 3, 2005

(54) Flexible trimmer head

(76) Inventor: Marcus Nystrom, Jonkoping (SE)

Correspondence Address: PEARNE & GORDON LLP, 1801 EAST 9TH STREET, SUITE 1200, CLEVELAND, OH, 44114-3108, US

(21) Appl. No.: 10/686,926

(22) Filed: Oct. 16, 2003

(30) Foreign Application Priority Data
Oct. 25, 2002 (SE) 0203158-1

(51) Int. Cl. A01D 34/00

(52) U.S. Cl. 56/12.7

(57) ABSTRACT

Trimmer head for a portable engine powered tool comprising one or more cutting filaments stored winded on a related bobbin placed inside the trimmer head. The components in the trimmer head that are related to the unwinding of cutting filament from the bobbin are replaceable so that it is possible to alternate the type of activation for unwinding of cutting filament by changing selected components in the trimmer head.

This patent application relates to a new type of trimmer head that increases the flexibility of the portable tool.

Different types of trimmers are frequently used tools for cutting grass and low vegetation. These tools are suitable for cutting in areas where it is difficult to use a lawn mover or bigger machines because of for example a shifting countryside, threes or similar stopping the lawn mover and around edges of lawns or close to flower beds, plants or fences and other obstacles.

There are different types of trimmers but most of them have a working tool placed in one end of a tube while the engine and thereto-related components are placed in the other end of the tube. The length of the tube as well as the type of working tool is selected to meet the requirements for the specific vegetation that the trimmer will be used for. The working tool is normally a saw blade or a trimmer head provided with one or more cutting filaments.

When a cutting filament is used for cutting is the length of the filament reduced because of wear from the vegetation and must therefore be replaced. Cutting filament is stored for example on a bobbin placed inside the trimmer head so that new cutting filament is unwinded from the bobbin when the cutting filament is to short.

There are three different solutions for activating the unwinding of cutting filaments from the bobbin or bobbins placed inside the trimmer head, manual activation, semiautomatic activation and automatic activation.

If manual activation for unwinding of cutting filament is used is the unwinding activated by a button placed on the topside of the trimmer head where it is easy for the operator to reach and press. When the operator presses the button is a predetermined length of cutting filament unwinded from the bobbin inside the trimmer head.

Semiautomatic activation of cutting filament means that the trimmer head is provided with button for activation of unwinding of cutting filament placed on the bottom side of the trimmer head. The operator activates the unwinding of cutting filament by pressing the entire trimmer head towards the ground so that the button is pressed without stopping the rotation of the trimmer head. A predetermined length of cutting filament is then unwinded.

If the trimmer head is provided with automatic unwinding of cutting filament is the cutting filament replaced automatically without involving any action from the operator.

Different solutions of these three types of trimmer heads are used in different applications. The operator may for some reason prefers one type of solution for activating of unwinding of cutting filament in some cases and another type when the circumstances are different. To change the type of unwinding of cutting filament on known trimmer heads must the entire trimmer head be replaced. This means that the operator must have three different trimmer heads, which is expensive for the operator to purchase but also for the producer that must manufacture and keep a lot of different components in stock to have spare parts for all trimmer heads.

The invention disclosed in this application and defined in the claims solves the problems described above by a new design of the trimmer head. The new trimmer head is designed so that selected parts of the mechanism for unwinding of cutting filament and the trimmer head housing are replaced while the other components in the trimmer head are used for all types of trimmer heads no matter of which type of activation of unwinding the trimmer head is using. This makes it possible for the operator to alternate between manual, semiautomatic or automatic activating of unwinding without changing the entire trimmer head.

This means that the number of components are reduced and consequently also the amount of accessories for the trimmer head. This is also favorable for the manufacturer since the numbers of different components to produce are reduced as well as the number of spare parts that must be available for the operators.

The trimmer head comprises a dividable trimmer head housing that surrounds one or more bobbins where a cutting filament or filaments are stored winded on the bobbin or bobbins. The trimmer head is normally provided with one or two cutting filaments. The top section of the trimmer head housing is attached in the end of the tube and secured to the drive shaft extending from the engine in the to the trimmer head. The mechanism for unwinding of cutting filament is normally arranged in the top section of the trimmer head housing. The mechanism is designed to fit in the centre of the bobbin or bobbins where the cutting filament or filaments are stored. The mechanism is thereby in contact with the bobbin or bobbins so that they are either locked or rotated in order to unwind cutting filament from the bobbin. The lower section of the trimmer head housing is the same no matter of which type of solution that is used for activating unwinding of cutting filament.

The claimed invention is illustrated in the attached drawings.

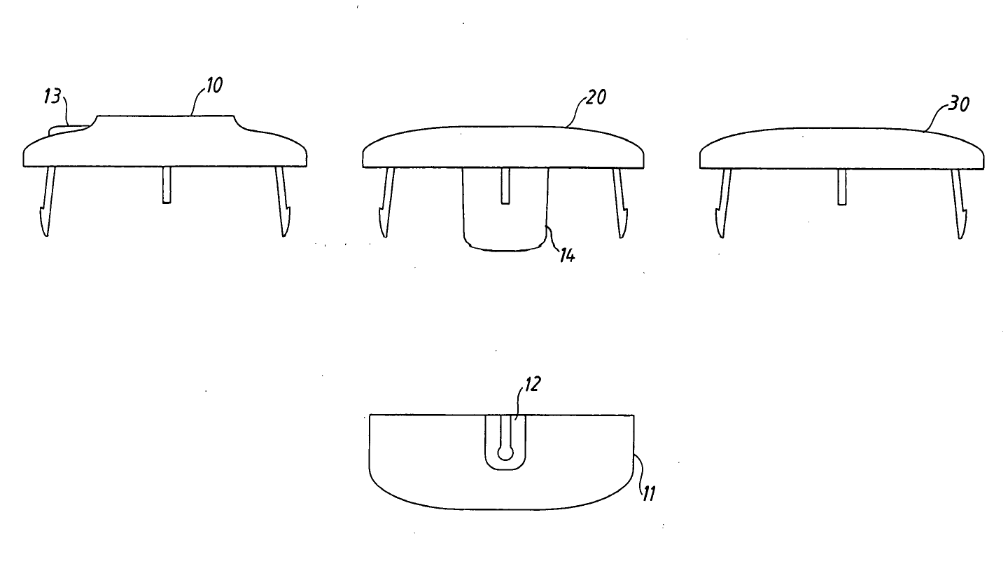

FIG. 1. Illustrates a trimmer head and the different systems for activation unwinding of cutting filament.

I FIG. 1 is a simple FIGURE illustrating the trimmer head defined in the claims. The trimmer head comprises a trimmer head housing. The trimmer head housing comprises at least a top section that in this case is three different top section, a first top section 10 provided with manual activation of unwinding of cutting filament, a second top section 20 provided with semiautomatic activation and a third top section 30 for automatic activation of cutting filament. The trimmer head also comprises a cup shaped lower section 11 surrounding one or more bobbins, not illustrated in the FIGURE, where cutting filament is stored winded on the bobbin or bobbins. The cutting filament is lead form the bobbin or bobbins through the cup shaped lower section 11 via an eyelet 12. The eyelet 12 is provided with an opening slightly bigger than the diameter of the cutting filament. The trimmer head may have one or more cutting filaments and the number of eyelets 12 equals the number or cutting filaments in the trimmer head.

The top sections 10, 20, 30 of the trimmer head, the cup shaped lower section 11 and the bobbin or bobbins are made of an appropriate plastic material while the eyelets 12 are made of a material more resistant to wear from the cutting filament when the tool is used.

On the side facing upwards on the first top section 10 is a button 13 placed to activate the mechanism for unwinding of cutting filament. The mechanism is arranged in the first top section 10. The operator stops the rotation of the trimmer head and presses the button 13 to activate the unwinding of a predetermined length of cutting filament from the bobbin where the cutting filament is stored.

The second top section 20 is used when the operator prefers to use semiautomatic activation of unwinding of cutting filament. The second top section 20 do not have a button but is provided with a hub 14 in connection with the mechanism for unwinding of cutting filament arranged in the second top section 20. The operator activates the unwinding of cutting filament by pressing the entire trimmer head towards the ground. The rotation of the trimmer head is not stopped to activate the unwinding. The hub 14 is placed on the side of the trimmer head facing towards the ground and is thereby pressed and the unwinding of cutting filament activated when the trimmer head is pressed towards the ground. The hub 14 is connected to the mechanism for unwinding of cutting filament and extend from the second top section 20 through the centre of the bobbin or bobbins and finally through an opening in the bottom side of the cup shaped lower section 11 so that the hub 14 is exposed on the side of the trimmer head facing towards the ground.

The third top section 30 is used when automatic activation of unwinding of cutting filament is requested. The mechanism for unwinding of cutting filament is sensitive to the rotation speed of the trimmer head and is continually when the length of cutting filament is reduced feeding new cutting filament when the tool is used. No cutting filament is fed when the trimmer head not is rotating.

The cup shaped lower section 11, the eyelets 12 and the not illustrated bobbin or bobbins where the cutting filament is stored are the same components no matter of which top section that is used.

The operator only needs to change the top section and related mechanism for unwinding of cutting filament to alternate between the different types of systems for activating unwinding of cutting filament.

1. Trimmer head comprising a trimmer head housing, said trimmer head housing comprising at least a top section (10, 20, 30) and a lower section (11), said trimmer head housing surrounding one or more bobbins for storing of one or more cutting filaments winded on a bobbin and a mechanism for unwinding of the cutting filament or filaments, characterized in that the mechanism for unwinding of cutting filament placed inside the trimmer head housing is replaceable so that it is possible to alternate between manual, semiautomatic or automatic activation of unwinding of cutting filament from the bobbin or bobbins.

2. Trimmer head according to claim 1, characterized in that the mechanism for unwinding of cutting filament is arranged in the top section (10, 20, 30).

3. Trimmer head according to claim 2, characterized in that the top section (10, 20, 30) of the trimmer head housing and the mechanism for unwinding of cutting filament is replaced when the system for activating the unwinding is changed.

4. Trimmer head according to claim 3, characterized in that there are three different top sections, a first top section (10) for manual activation of unwinding of cutting filament, a second top section (20) for semiautomatic activation of unwinding of cutting filament and a third top section (30) for automatic unwinding of cutting filament.

5. Trimmer head according to claim 4, characterized in that the unwinding of cutting filament is activated by a button (13) placed on the side of the top section facing upwards when the first top section (10) is used.

6. Trimmer head according to claim 4, characterized in that the unwinding of cutting filament is activated by a hub (14) placed on the side of the trimmer head facing towards the ground when the second top section (20) is used.

7. Trimmer head according to claim 4, characterized in that the unwinding of cutting filament is activated automatically by the mechanism for unwinding of cutting filament in the trimmer head at a predetermined rotation speed when the third top section (30) is used.

8. Trimmer head according to any of the previous claims, characterized in that the lower section (11) is cup shaped and comprises an eyelet (12) for each cutting filament.
